(19) United States
(12) Patent Application Publication
(10) Pub. No.: US 2013/0304547 A1
(43) Pub. Date: Nov. 14, 2013

(54) INVESTMENT VALUATION PROJECTIONS IN AN ON-DEMAND SYSTEM

(71) Applicant: SALESFORCE.COM, INC., San Francisco, CA (US)

(72) Inventors: Ari Adler, Wilmington, NC (US); Nicholas Hellbusch, Westminster, CA (US); Reena Bhatia, San Francisco, CA (US); Nadia Naderi, Tiburon, CA (US)

(21) Appl. No.: 13/842,200

(22) Filed: Mar. 15, 2013

Related U.S. Application Data
(60) Provisional application No. 61/644,028, filed on May 8, 2012.

(51) Int. Cl. G06Q 10/06

(52) U.S. Cl. CPC G06Q 10/06393
USPC 705/7.39

(57) ABSTRACT

Methods and systems are provided for providing projected investment returns for a product to a user of a client device coupled to a server via a network. One exemplary method involves obtaining metadata from a database object associated with the product from a database coupled to the server, generating a graphical user interface element within an application provided to the client device based on the metadata, and receiving an input value responsive to the graphical user interface element from the client device via the application. The method continues by obtaining a formula for a valuation metric from the database, calculating a projected value for the valuation metric based at least in part on the input value using the formula, and generating a graphical representation of the projected value within the application.

### CROSS-REFERENCE TO RELATED APPLICATION(S)

This application claims the benefit of U.S. provisional patent application Ser. No. 61/644,028, filed May 8, 2012, the entire content of which is incorporated by reference herein.

### TECHNICAL FIELD

Embodiments of the subject matter described herein relate generally to computer systems, and more particularly, embodiments of the subject matter relate to methods and systems for providing projections for investment valuation metrics in an on-demand computing system.

### BACKGROUND

Return on investment (ROI) and other investment valuation metrics are frequently calculated or otherwise projected and used as part of a cost-benefit analysis assessing whether or not a particular product, service, asset, or the like should be purchased or otherwise acquired. Often, the projections for the investment valuation metrics of interest are determined using spreadsheets that are customized for a particular product or service of interest. However, as features are added to or removed from a particular product or service over time, the spreadsheet must be updated (e.g., by adding or removing cells in the spreadsheet, modifying formulas for existing cells in the spreadsheet, or the like) to account for the changes to the features associated with the product or service. Furthermore, spreadsheets are relatively inflexible when it comes to calculating ROIs for customizable combinations of products or services. For example, a company may have spreadsheets for the individual products or services (or certain combinations thereof) offered by that company, but over time, the company may acquire or merge with other companies, resulting in numerous additional products or services that may be bundle or packaged with the company's previously offered products and services. While spreadsheets may be manually configured for each possible combination of products and services, those spreadsheets may become obsolete as soon as the company adds new products and services or discontinues prior products or services.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary on-demand application system;

FIG. 2 is a flow diagram of an exemplary presentation process suitable for implementation by the on-demand application system of FIG. 1 in accordance with one or more embodiments;

FIGS. 3-9 illustrate exemplary graphical user interface displays that may be presented on a client computing device in the multi-tenant system of FIG. 1 in connection with the presentation process of FIG. 2 in an exemplary embodiment; and

FIG. 10 is a block diagram of an exemplary multi-tenant system suitable for use as the on-demand application system of FIG. 1 in accordance with one or more embodiments.

### DETAILED DESCRIPTION

Embodiments of the subject matter described herein generally relate to performing investment valuation metric projections (e.g., return on investment (ROI) metrics, total cost of ownership (TOC) metrics, and/or the like) for a product in an on-demand application system in a manner that is both flexible (e.g., to accommodate changes to the products being offered) and portable (e.g., to allow users to obtain projections on different devices). As used herein, a product should be understood as referring to any product, service, property, asset, or the like that may be purchased or otherwise acquired from a provider, and an investment valuation metric should be understood as referring to any ROI (or return) metric, TOC (or cost) metric, or any other suitable metric quantifying the relative value of a particular product. Although the subject matter may be described herein in the context of an ROI application, an ROI presentation, or the like, the term ROI is used for clarity and ease of explanation and is not intended to be limiting. In this regard, an ROI application may include TOC (or cost) metrics or other investment valuation metrics and it not necessarily limited ROI (or return) metrics. It will be appreciated that the subject matter described herein is not limited to any particular investment valuation metric for quantifying the return, performance, or efficiency of a particular product.

In exemplary embodiments, computer-executable code segments, instructions, scripts or the like for a virtual ROI application are stored or otherwise maintained on a database and executed by a server to provide an instance of the virtual ROI application to a user of a client device via a communications network. The virtual ROI application code invokes GUI display database objects in accordance with an ROI presentation sequence to sequentially generate and provide the GUI displays to the client device in the order corresponding to the presentation sequence. As described in greater detail below, the fields of metadata for a respective GUI display database object invokes or otherwise references other database objects, wherein one or more fields of metadata of those referenced database objects are utilized to populate the GUI elements of the GUI display. Accordingly, the GUI displays of the ROI presentation sequence may be modified or otherwise updated to reflect changes to the products offered by a particular provider by modifying or otherwise changing the database objects referenced by the GUI display database objects and without having to modify the code for the virtual ROI application.

The GUI elements in the GUI displays of the ROI presentation may be manipulated by the user of the client device select particular products and/or product areas of interest for which the user would like to obtain ROI projections and provide user inputs pertaining to the selected products and/or product areas or otherwise relating to operations of the business entity interested in purchasing or acquiring the selected products and/or product areas. The server receives the user inputs via the virtual ROI application and stores or otherwise maintains values corresponding to the received user inputs in the database in association with the particular ROI presentation and/or the GUI displays to which they pertain. Thereafter, once the user has progressed through the data collection GUI displays of the ROI presentation sequence, the virtual ROI application code causes the server to generate a ROI results GUI display (or ROI summary) within the virtual ROI application. To calculate the projected values for the various investment valuation metrics used to populate the ROI results GUI display, the server accesses the database to obtain valuation metric formula objects associated with the selected products and/or product areas. As described below, each valuation metric formula object includes one or more fields of metadata that define the formula for calculating a projected (or estimated) value for that respective investment valuation metric as a function of one or more received user input values. For example, the variables or parameters of the function for the respective valuation metric formula may expressed in terms of the particular GUI displays and/or GUI elements from which the corresponding user input values are received from, wherein the server obtains the appropriate received user input values from the response database objects associated with the identified GUI displays and/or GUI elements and calculates a projected value for that investment valuation metric as a function of those obtained user input values. Accordingly, the formulas for the investment valuation metrics incorporated into the ROI presentation sequence may be modified or otherwise updated to reflect changes to the products offered by a particular provider by modifying, adding, or otherwise changing the associated formula database objects rather than modifying the code for the virtual ROI application.

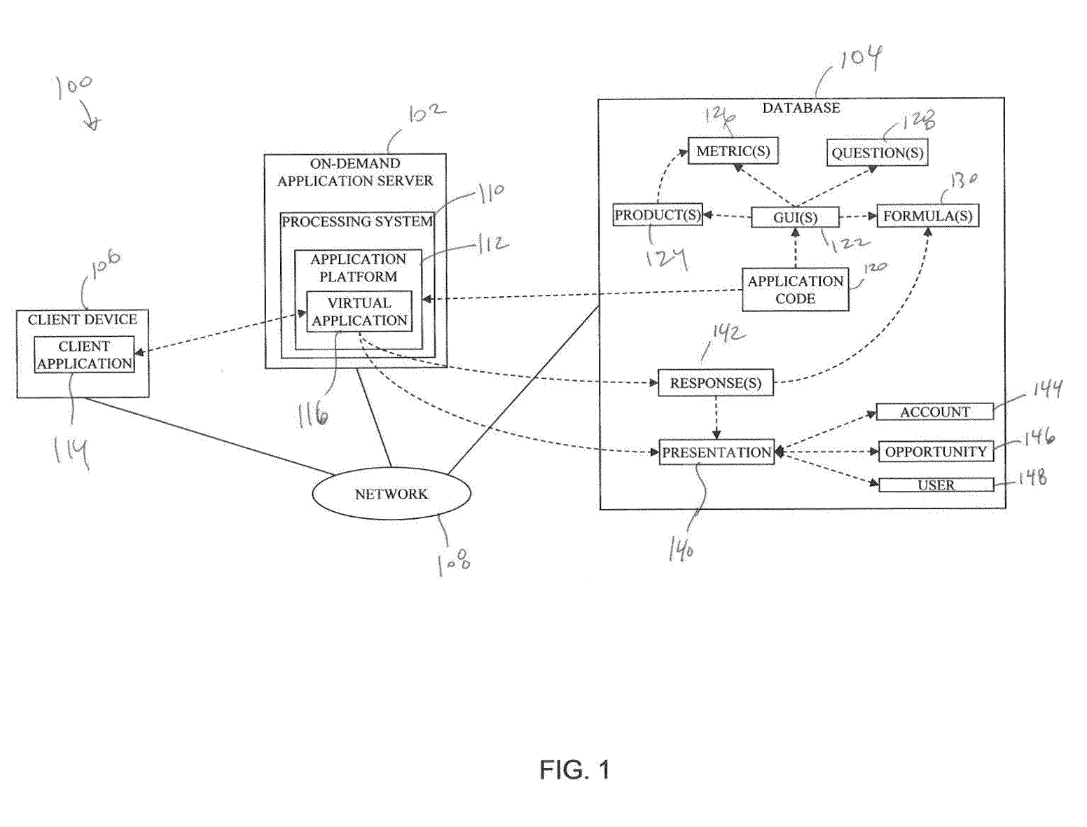

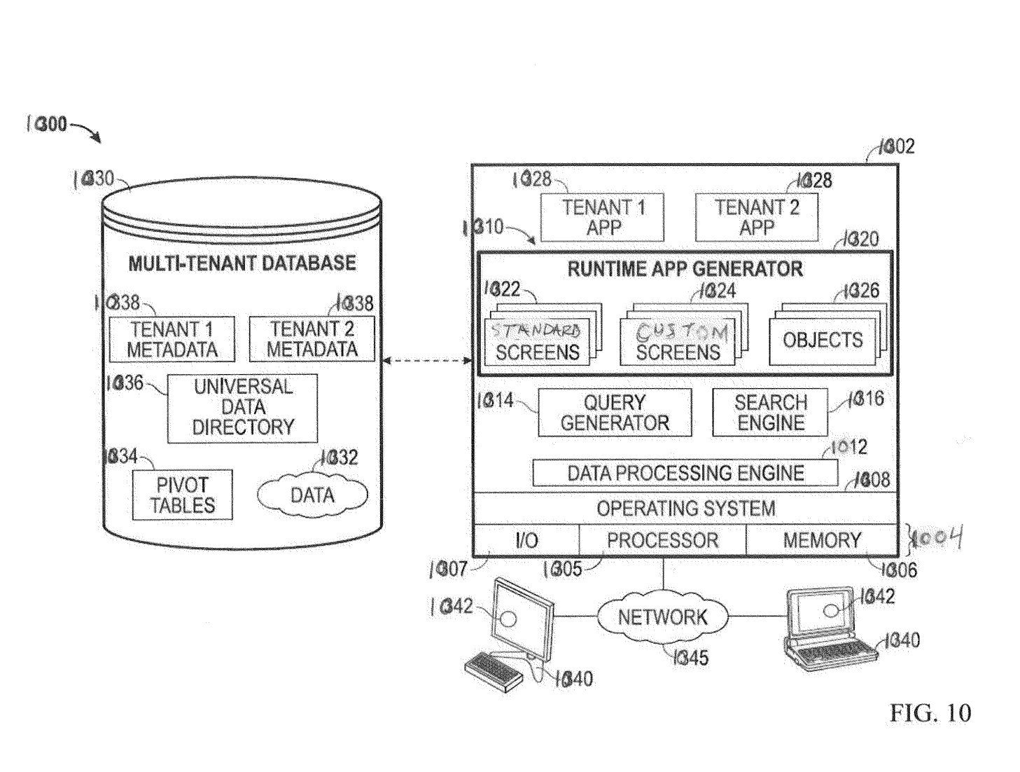

Turning now to FIG. 1, an exemplary on-demand application system 100 includes an application server 102 that includes or otherwise implements an application platform 112 capable of generating one or more instances of a virtual application 116 at run-time (e.g., or “on-demand”) based upon data stored or otherwise maintained by a database 104 that is communicatively coupled to the application server 102 via a communications network 108, such as a wired and/or wireless computer network, a cellular network, a mobile broadband network, a radio network, or the like. In this regard, the application server 102 and the database 104 cooperatively provide a cloud computing platform (or framework). In accordance with one or more embodiments, the database 104 is realized as a multi-tenant database that is shared between multiple tenants, that is, the database 104 may store or otherwise maintain data associated with a number of different tenants, as described in greater detail below in the context of FIG. 10.

In the illustrated embodiment of FIG. 1, the server 102 generally represents a computing system or another combination of processing logic, circuitry, hardware, and/or other components configured to support the presentation processes and the related tasks, operations, and/or functions described herein. In this regard, the application server 102 includes a processing system 110, which may be implemented using any suitable processing system and/or devices, such as one or more processors, central processing units (CPUs), controllers, microprocessors, microcontrollers, processing cores and/or other computing resources configured to support the operation of the processing system 110 described herein. The processing system 110 may include or otherwise access a data storage element (or memory) (e.g., random access memory (RAM), read only memory (ROM), flash memory, magnetic or optical mass storage, or any other suitable non-transitory short or long term data storage or other computer-readable media) capable of storing programming instructions for execution by the processing system 110, that, when read and executed, cause processing system 110 to create, generate, or otherwise facilitate an application platform 112 that generates or otherwise provides the virtual application 116 at run-time (or “on-demand”) based upon data stored or otherwise maintained by the database 104.

In exemplary embodiments, the virtual application 116 is provided to a client device 106 communicatively coupled to the application server 102 via the network 108. In this regard, the client device 106 generally represents an electronic device coupled to the network 108 that is utilized by the user to access the application platform 112 and/or virtual application 116 on the server 102. In practice, the client device 106 can be realized as any sort of personal computer, mobile telephone, tablet or other network-enabled electronic device that includes a display device, such as a monitor, screen, or another conventional electronic display, capable of graphically presenting data and/or information provided by the application platform 112 and/or the virtual application 116 along with a user input device, such as a keyboard, a mouse, a touchscreen, or the like, capable of receiving input data and/or other information from the user of the client device 106. A user may manipulate the client device 106 to execute a client application 114, such as a web browser application, and contact the application server 102 and/or application platform 112 using a networking protocol, such as the hypertext transport protocol (HTTP) or the like. The application platform 112 authenticates or otherwise identifies the user and generates the virtual application 116 at run-time based upon information and/or data associated with the user maintained by the database 104. In this regard, the virtual application 116 may include code, data and/or other dynamic web content provided to the client device 106 that is parsed, executed or otherwise presented by the client application 114 running on the client device 106.

In exemplary embodiments, the virtual application 116 corresponds to a ROI application provided by the server 102 that includes one or more GUI displays generated by the server 102 based on metadata obtained from the database 104. The GUI displays pertain to one or more products offered by a provider (e.g., the administrator of the database 104) that include GUI elements or widgets that allow the user of the client device 106 to select or otherwise identify the product(s) of interest to the user (e.g., the product(s) for which the user would like ROI projections) along with GUI elements or widgets that allow the user to select or otherwise identify area(s) of interest that are associated with those selected product(s). In this regard, the product areas represent categories, features, or other aspects of a particular product that correlate to the relative value of (or return associated with) that product. In other words, the product areas represent the value drivers for a particular product. Additionally, the virtual application 116 includes data collection GUI displays including GUI elements or widgets that prompt or otherwise request the user to input or otherwise provide values for various parameters, variables, or other categories or types of information pertaining to the selected products, the selected product areas, and/or the business operations of the business entity interested in the selected product(s). After receiving the user input values quantifying various aspects of the selected products, the selected product areas, and/or the acquiring business entity's operations, the server 102 and/or application platform 112 obtains, from the database 104, one or more formulas for calculating projected (or estimated) values for valuation metrics associated with the selected product(s) based on the received user input values and calculates or otherwise determines the projections a function of the received user input values using corresponding variables or parameters of the valuation metric formula (s) obtained from the database 104. Thereafter, the server 102 and/or application platform 112 generates or otherwise provides graphical representation(s) of the projected valuation metric(s) associated with the selected product(s) within the virtual application 116, thereby allowing the user of the client device 106 to identify, assess, and/or analyze the relative value of the selected product(s) (e.g., the projected and/or estimated ROI if the selected product(s) were purchased by the business entity) based on the received user input values.

In exemplary embodiments, the server 102 and/or application platform 112 accesses the database 104 to obtain or otherwise retrieve the ROI application code 120, which includes the computer-executable code segments, instructions, scripts or the like that are executed by the processing system 110 and/or application platform 112 to generate the virtual ROI application 116. The ROI application code 120 presents an ordered sequence of GUI displays, alternatively referred to herein as a presentation. In this regard, the ROI presentation includes a sequence of GUI displays configured to prompt the user of the client device 106 to input or otherwise provide, via GUI elements contained in the GUI displays, values indicative of the particular products and/or product areas that the user is interested in determining ROIs for, along with prompting the user to provide input values that quantify or otherwise pertaining to various aspects of those selected products and/or product areas. The received user input values are utilized by the virtual application 116 and/or application platform 112 to calculate one or more valuation metrics corresponding to the selected products and/or product areas as a function of the received user input values and generate or otherwise provide a results (or summary) GUI display at the end of the presentation sequence that includes a graphical representation of the valuation metrics. The ROI application code 120, when read and executed, causes the virtual application 116 and/or application platform 112 to invoke or otherwise reference GUI objects 122 stored in the database 104 that correspond to the GUI displays of the presentation in the order corresponding to the presentation sequence.

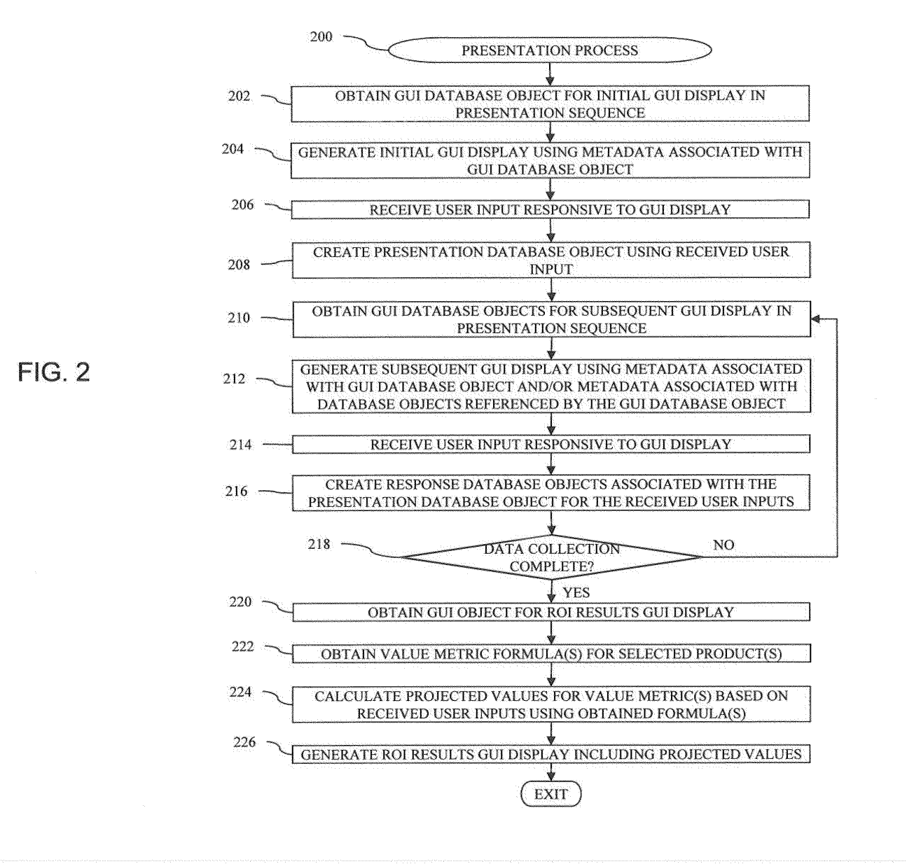

In exemplary embodiments, each GUI database object 122 includes or is otherwise associated with a field of metadata that defines the order of the GUI display corresponding to that respective GUI database object 122 in the presentation sequence. In this regard, the ROI application code 120 causes the virtual application 116 and/or application platform 112 to identify the appropriate GUI display database object 122 in the presentation sequence based on the field of metadata defining the order of that respective GUI display database object 122 relative to a preceding and/or previously invoked GUI display database object 122. Additionally, each GUI database object 122 includes or is otherwise associated with fields of metadata that define the layout of GUI elements or widgets within the corresponding GUI display presented within the virtual application 116. To populate the GUI displays of the presentation, one or more fields of metadata of the GUI database objects 122 may reference one or more fields of metadata of one or more other database objects, such as, for example, product database objects 124, product area database objects 126, question database objects 128 and/or formula database objects 130 as described in greater detail below in the context of FIGS. 2-9. In this regard, a GUI display database object 122 may cause the processing system 110 and/or application platform 112 to reference metadata associated with a respective product object 124, product area database object 126, question database object 128 and/or formula database object 130 to populate a particular GUI element or widget within a GUI display. For example, a field of a GUI display database object 122 may include a code segment or script that is executed by the processing system 110 and/or application platform 112, which, in turn, causes the processing system 110 and/or application platform 112 to retrieve or otherwise obtain the metadata needed to populate the GUI elements of the GUI display from the appropriate product object 124, product area database object 126, question database object 128 and/or formula database object 130.

In exemplary embodiments, each product database object 124 corresponds to a particular product offered by a particular product provider and includes one or more fields of metadata that describe or otherwise define the product database object 124. Additionally, each product is associated with one or more product areas, with each product area corresponding to an aspect of the product that impacts or otherwise influences the relative value of the product (e.g., a value driver). In this regard, for a respective value driving aspect of a product, the product database object 124 corresponding to that product may include a field of metadata that references the product area object 126 (or one or more fields thereof) corresponding to that respective value driving aspect of the product. In this regard, each product area object 126 is associated with a product database object 124.

As described in greater detail below, in exemplary embodiments, each GUI display database object 122 references or is otherwise associated with one or more question database objects 128, wherein the question database object 128 includes one or more fields of metadata that define which questions that a user should be asked or otherwise prompted with at a given GUI display in the presentation sequence. For example, a GUI display object 122 may include a first field of metadata defining a text box, pull-down menu, or other user GUI input element capable of being manipulated by a user of the client device 106 to receive a user input value along with a second field of metadata associated with that first field of metadata that references a field of metadata of a question database object 128 that defines the textual information and/or label to be rendered in association with the user GUI input element to indicate, to the user of the client device 106, what the user GUI input element corresponds to. Depending on the embodiment, some question database objects 128 may be generic or independent so that they are always presented to the user of the client device 106 regardless of the selected products and/or product areas, while other question database objects 128 may be associated with a particular product and/or product area so that they are only presented when that particular product and/or product area has been previously selected for inclusion in the presentation. For example, the question object 128 for a product-specific and/or product area-specific question may include a field of metadata that includes a code segment or script that is executed by the processing system 110 and/or application platform 112, which, in turn, causes the processing system 110 and/or application platform 112 to retrieve or otherwise obtain the metadata used to generate the label for the GUI element associated with the respective product-specific and/or product area-specific question from the respective product database object 124 and/or product area object 126.

Additionally, one or more GUI database objects 122 reference one or more formula database objects 130 that define the formulas for calculating projected investment valuation metrics for a particular product as a function of the user input values provided via the GUI input elements in response to one or more questions that were presented to the user of the client device 106 based on the GUI database objects 122 and/or the question database objects 128 associated with preceding GUI displays in the presentation. For example, a GUI display database object 122 may be associated with a ROI results GUI display generated by the processing system 110 and/or the application platform 112 within the virtual application 116, wherein one or more fields of the metadata for the results GUI display database object 122 reference one or more formula database objects 130 to obtain the appropriate formulas for calculating valuation metrics for the selected product, calculate the estimated or projected valuation metric based on the received user input values, and generate or otherwise provide a graphical representation of the calculated valuation metric within the results GUI display. As described above, the metadata associated with a respective formula database object 130 defines the formula for calculating a projected (or estimated) value for that respective investment valuation metric as a function of one or more received user input values, for example, by referencing the particular GUI display database object 122 and/or the question database object 128 from which a corresponding user input value is received from.

To facilitate calculating the valuation metric(s) for the selected product(s) for a presentation, in exemplary embodiments, the application code 120 causes the processing system 110 and/or the application platform 112 to generate or otherwise create response database objects 142 that maintain an association between one or more user input values received from the client device 106 in response to particular questions or prompts within a GUI display of the virtual application 116 the user input values correspond to. For example, for each GUI display object 122, the processing system 110 and/or the application platform 112 may generate a response database object 142 that maintains an association between the user input values received in response to that GUI display and their corresponding GUI input elements. Additionally, as described below, the application code 120 causes the processing system 110 and/or the application platform 112 to generate or otherwise create a presentation database object 140 that maintains an association between all of the response data objects 142 associated with a particular presentation.

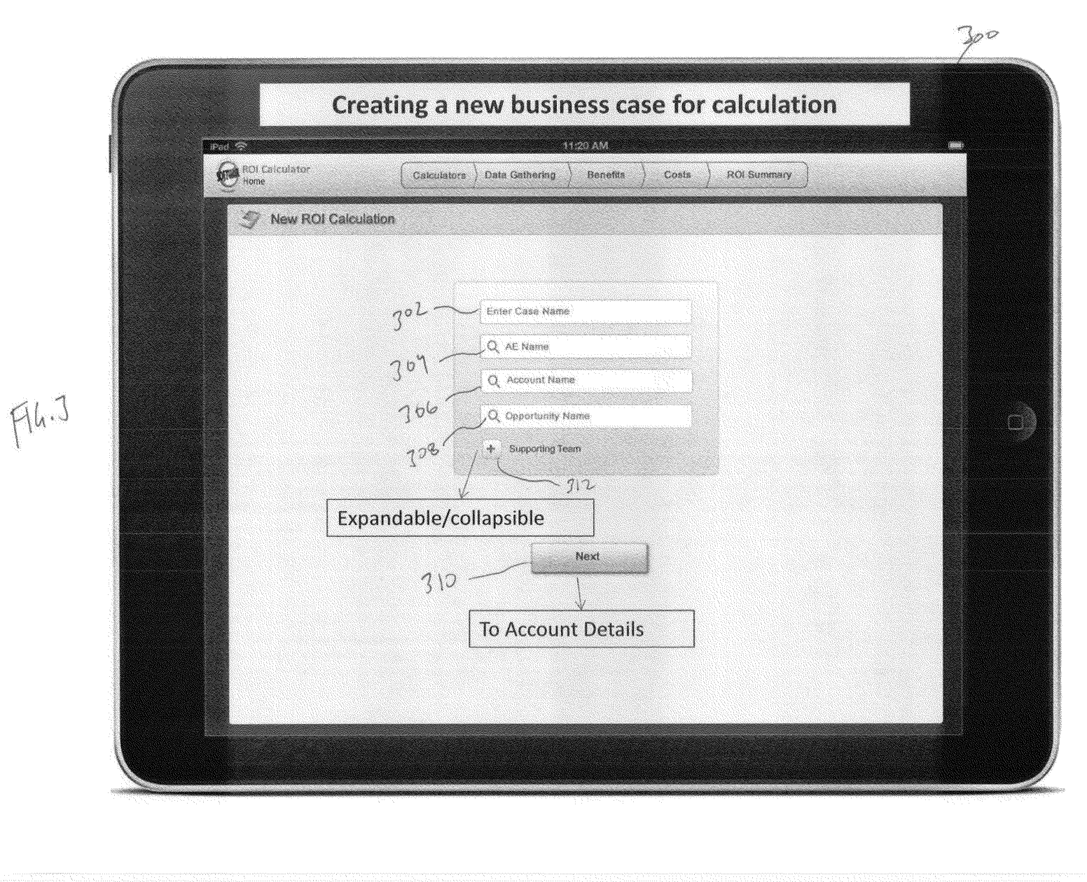

In exemplary embodiments, when the database 104 is realized as a multi-tenant database supporting a plurality of different tenants, the presentation database object 140 includes a field of metadata that maintains an association between the presentation database object 140 and the tenant that the user of the client device 106 is associated with or otherwise belongs to. For example, the presentation database object 140 may include a tenant field that is set to the value of the tenant identifier for the tenant the user of the client device 106 is associated with. Additionally, in the illustrated embodiment, the presentation database object 140 includes one or more fields of metadata that maintain associations between the presentation database object 140 and one or more of an account database object 144, an opportunity database object 146 and/or a user database object 148. For example, the user may manipulate the virtual application 116 to associate the presentation with a particular account and/or opportunity associated with that user and/or the user's tenant, or a particular user supported by the multi-tenant database 104, as described in greater detail below in the context of FIGS. 2-3.

Still referring to FIG. 1, to modify the virtual ROI application 116 to incorporate modifications or changes to products offered by a provider into a presentation, the corresponding product database objects 124 and/or product area database objects 126 may be modified or changed without having to modify the application code 120 and/or the GUI database objects 122. In this regard, to add a product and/or product area to a presentation, a corresponding product database object 124 and/or product area database object 126 may be created in the database 104 and/or the corresponding product database object 124 and/or product area database object 126 may otherwise be made active or visible. For example, the metadata associated with a GUI display database object 122 corresponding to a product selection GUI display of the presentation may cause the processing system 110 and/or the application platform 112 to automatically generate GUI input elements corresponding to each product database object 124 in the database 104 having a status field of metadata that indicates that product is active, visible, or otherwise available for inclusion in a presentation. Thus, to support a new product, a new product database object 124 corresponding to that new product maybe created or otherwise instantiated in the database 104 with a status field of metadata set to indicate that the new product is active, visible, or otherwise available for inclusion into a presentation. As a result, when the GUI display is generated based on the metadata associated with product selection GUI display database object 122, the new product database object 124 is identified as being available for inclusion and an GUI input element enabling selection that of new product for inclusion into the presentation is automatically generated or otherwise presented within the product selection GUI display. In a similar manner, for that new product database object 124, new product area database objects 126, new question database objects 128 and/or new formula database objects 130 corresponding to that product maybe created or otherwise instantiated in the database 104 with fields of metadata indicating that they are associated with the new product database object 124 and that they are active, visible, or otherwise available for inclusion into a particular presentation. For example, a GUI display database object 122 corresponding to a GUI display of the presentation that allows the user to select product areas for inclusion in a presentation may cause the processing system 110 and/or the application platform 112 to automatically generate GUI input elements corresponding to the product area database objects 126 associated with the product database object 124 corresponding to new product.

Conversely, to deactivate or otherwise remove a particular product and/or product area from being included in a presentation, the corresponding product database object 124 and/or product area database object 126 may be deleted from the database 104 or the status fields of metadata of the corresponding product database object 124 and/or product area database object 126 may otherwise be set to indicate those respective objects 124, 126 are inactive or invisible. Thus, when a GUI display database object 122 corresponding to a GUI display of the presentation that allows the user to select products and/or product areas for inclusion in a presentation causes the processing system 110 and/or the application platform 112 to generate GUI input elements corresponding to each product database object 124 and/or product area database object 126 in the database 104 having a status field of metadata that indicates that product is active, visible, or otherwise available for inclusion, the removed and/or deactivated product database object 124 and/or product area database object 126 is automatically left out of the GUI display. Accordingly, the structure of the virtual ROI application 116 is flexible and accommodates any number of products, product areas, questions, and/or investment valuation metrics, and thus, as the provider's product offerings (or aspects thereof) vary over time, the virtual ROI application 116 may be modified and updated accordingly without having to modify the application code 120. Rather, as described above, modifications to the virtual ROI application 116 may be achieved merely by creating and/or deleting database objects 122, 124, 126, 128, 130 or otherwise modifying fields of metadata for the database objects 122, 124, 126, 128, 130 utilized by the application code 120 to generate the presentation.

FIG. 2 depicts an exemplary embodiment of a presentation process 200 suitable for implementation by an on-demand application system, such as on-demand application system 100, to generate a sequence of GUI displays to receive user input pertaining to one or more selected products, calculate projected values for one or more investment valuation metrics for the selected product(s) based on the user input, and present the calculated projected values to a user so that the user can analyze or otherwise assess the likely ROI associated with the selected product(s). The various tasks performed in connection with the illustrated process 200 may be performed by software, hardware, firmware, or any combination thereof. For illustrative purposes, the following description may refer to elements mentioned above in connection with FIG. 1. In practice, portions of the presentation process 200 may be performed by different elements of the on-demand application system 100, such as, for example, the server 102, the database 104, the processing system 110, the application platform 112, the virtual application 116, and/or the application code 120. It should be appreciated that the presentation process 200 may include any number of additional or alternative tasks, the tasks need not be performed in the illustrated order and/or the tasks may be performed concurrently, and/or the presentation process 200 may be incorporated into a more comprehensive procedure or process having additional functionality not described in detail herein. Moreover, one or more of the tasks shown and described in the context of FIG. 2 could be omitted from a practical embodiment of the presentation process 200 as long as the intended overall functionality remains intact.

Referring to FIG. 2, and with continued reference to FIG. 1, in an exemplary embodiment, the presentation process 200 initializes or otherwise begins in response to the processing system 110 and/or the application platform 112 of the server 102 retrieving or otherwise obtaining the presentation application code 120 from the database 104 via the network 108 and executing the obtained application code 120 to generate or otherwise create an instance of the virtual ROI application 116 provided to a client device 106 via the network 108. In exemplary embodiments, the user of the client device 106 manipulates the client application 114 to interact with the application server 102 and/or the application platform 112 in a manner that causes the application server 102 and/or the processing system 110 to obtain and execute the presentation application code 120. For example, the user of the client device 106 may direct the client application 114 to a particular network address or location on the server 102, wherein in response to receiving the request for that particular network address or location, the server 102 and/or the processing system 110 accesses the database 104 to retrieve the application code 120 and automatically executes the application code 120 to generate the virtual ROI application 116 provided to the client device 106 within the client application 114.

In the illustrated embodiment, the presentation process 200 begins by generating or otherwise providing an initial GUI display including GUI elements adapted to allow a user to define a new ROI presentation, receiving user input defining the presentation, and generating or otherwise creating a presentation database object in the database that corresponds to the new ROI presentation based on the received user input (tasks 202, 204, 206). In this regard, the application code 120 may identify a GUI display database object 122 corresponding to a presentation definition GUI display in the presentation sequence and cause the processing system 110 and/or application platform 112 to obtain that GUI display database object 122 from the database 104 and generate the presentation definition GUI display within the virtual application 116 based on the metadata associated with the presentation definition GUI display object 122. As described in greater detail below, in exemplary embodiments, the metadata for the presentation definition GUI display object 122 defines GUI input elements (e.g., text boxes or the like) adapted to allow the user to indicate or otherwise identify a desired name for the presentation, an account that the presentation is associated with, an opportunity the presentation is associated with, a particular user that the presentation is associated with, and/or the like. The GUI input elements are provided on the GUI display presented within the virtual application 116, wherein the user manipulates the client device 106 to input or otherwise provide values for the different fields, categories, or types of information associated with the GUI input elements. Thereafter, the user may manipulate the client device 106 to indicate that the user has finished providing the information defining the presentation.

In response to receiving the indication that the user has finished providing the information defining the presentation, the application code 120 causes the processing system 110 and/or application platform 112 to capture or otherwise receive the user input values via the various GUI input elements and create a corresponding presentation database object 140 in the database 104 using the received user input values. In this regard, the processing system 110 and/or application platform 112 sets the value for a name field of the presentation database object 140 to be equal to the user input value provided via the GUI element corresponding to the presentation name, sets the value for an account field of the presentation database object 140 to be equal to the user input value provided via the GUI element corresponding to the account name (thereby associating the presentation database object 140 with an account object 144 belonging to that user and/or tenant having the matching account name), sets the value for an opportunity field of the presentation database object 140 to be equal to the user input value provided via the GUI element corresponding to the opportunity name (thereby associating the presentation database object 140 with an opportunity object 146 belonging to that user and/or tenant having the matching opportunity name), and so on. In exemplary embodiments, the processing system 110 and/or application platform 112 also sets the value for a tenant identification field of the presentation database object 140 to be equal to the tenant identifier associated with the user of the client device 106.

Still referring to FIG. 2, after creating the presentation database object, the presentation process 200 continues by obtaining the GUI database object corresponding to the next GUI display in the presentation sequence and generating or otherwise providing the next GUI display using metadata associated with the obtained GUI database object and/or metadata associated with other database objects referenced by the obtained GUI database object (tasks 210, 212). In this regard, the application code 120 may identify the GUI display database object 122 corresponding to a data collection GUI display that follows the presentation definition GUI display in the presentation sequence and cause the processing system 110 and/or application platform 112 to automatically obtain that GUI display database object 122 from the database 104 and generate the corresponding data collection GUI display after creating the presentation database object 140.

In exemplary embodiments, the data collection GUI display that follows the presentation definition GUI display includes GUI elements adapted to allow the user of the client device 106 to select or otherwise indicate what products the user would like to include in the ROI presentation along with GUI elements adapted to allow the user of the client device 106 to select or otherwise indicate what product areas the user would like to include or otherwise incorporate in the ROI presentation. In this regard, a product selection GUI display database object 122 may include one or more fields of metadata corresponding to the active product objects 124 in the database 104, such that when the processing system 110 and/or application platform 112 generates the product selection GUI display within the virtual application 116, the processing system 110 and/or application platform 112 automatically populates the GUI elements of the product selection GUI display with metadata (e.g., the product name or the like) associated with active product objects 124 in the database 104. For example, the processing system 110 and/or application platform 112 automatically generate a list of the active products that includes GUI elements corresponding to each respective product to allow the user of the client device 106 to add/or remove that product from the presentation. Additionally, the product selection GUI display database object 122 may include one or more fields of metadata corresponding to the product area objects 126 associated with a selected product object 124, such that when the user selects a particular product for inclusion in the presentation, the processing system 110 and/or application platform 112 obtains the product area objects 126 associated with the selected product object 124 and automatically updates the product selection GUI display to include GUI elements adapted to allow a user to select or otherwise indicate the product areas associated with the selected product that the user would like to incorporate in the presentation.

The illustrated process 200 continues by receiving the user input provided in response to the GUI display via the GUI elements presented within the virtual application and creating corresponding response database objects in the database that maintain an association between the user input values and the presentation (tasks 214, 216). In this regard, after the user has manipulated the client device 106 to provide input in response to the GUI elements (e.g., by selecting or otherwise manipulating the GUI elements), the user may manipulate or otherwise select a GUI element (e.g., a button or the like) to indicate that the user has completed responding to the currently presented data collection GUI display. In response to receiving the indication that the user has finished providing the requested information, the application code 120 causes the processing system 110 and/or application platform 112 to capture or otherwise receive the user inputs corresponding to the various GUI input elements and create corresponding response database objects 142 associated with the presentation database object 140 in the database 104. In this regard, a respective response database object 142 may include a field of metadata having a value that indicates the presentation database object 140 it is associated with along with one or more fields of metadata that are equal to or otherwise correspond to the user input. Additionally, the respective response database object 142 may include one or more fields of metadata that associated the response database object 142 to the particular GUI display database object 122 and/or question database object 128 that the associated user input values were obtained from or otherwise pertain to.

In exemplary embodiments, the presentation process 200 continues by determining whether data collection for the ROI presentation has been completed, and when the user has not progressed through all of the data collection GUI displays of the presentation sequence, the presentation process 200 continues by obtaining the GUI database object corresponding to the next data collection GUI display in the presentation sequence, generating the next data collection GUI display using metadata associated with the obtained GUI database object and/or metadata associated with other database objects referenced by the obtained GUI database object, receiving user input provided in response to the data collection GUI display, and creating corresponding response database objects in the database that maintain an association between the user input values and the presentation (tasks 210, 212, 214, 216, 218). For example, as described above, the application code 120 may identify the GUI display database object 122 corresponding to a data collection GUI display that follows the product selection GUI display in the presentation sequence and cause the processing system 110 and/or application platform 112 to automatically obtain that GUI display database object 122 from the database 104 and generate the corresponding data collection GUI display after receiving the indication that the user has completed selecting products and their corresponding product areas for inclusion in the presentation. In exemplary embodiments, the subsequent data collection GUI display database object 122 in the presentation sequence references or is otherwise associated with a number of question database objects 128, wherein the processing system 110 and/or application platform 112 automatically populates the GUI elements of the data collection GUI display using metadata (e.g., the textual labels and/or question prompts) associated with question objects 128 referenced by the GUI display database object 122.

As described above, after the user has manipulated the client device 106 to provide input in response to the questions and/or prompts corresponding to the GUI elements on the data collection GUI display, the user may indicate that he or she has completed responding to the currently presented data collection GUI display, wherein in response to receiving the indication, the processing system 110 and/or application platform 112 create corresponding response database objects 142 associated with the presentation database object 140 that maintain an association between the presentation database object 140, the received user input, and the GUI display database object 122 and/or the question object 128 that that received user input corresponds to.

The loop defined by tasks 210, 212, 214, 216 and 218 may repeat to progress the user through the presentation sequence until the user has provided all the data and/or information required to calculate projected or estimated values for the valuation metrics associated with the selected product(s) and/or selected product area(s). For example, the application code 120 may determine that a general data collection GUI display including generic questions (e.g., question objects 128 that are not associated with a particular product object 124 and/or product area object 126) pertaining to the user's business operations and/or finances follows the product selection GUI display based on a field of metadata associated with the general data collection GUI display database object 122 indicating it follows the product selection GUI display database object 122. Additionally, the application code 120 may determine that, for each selected product and/or selected product area, a product-specific and/or product area-specific data collection GUI display follows the a general data collection GUI display, wherein the product-specific and/or product area-specific data collection GUI display is populated with metadata obtained from question database objects 128 that are associated with the selected product database object 124 and/or product area object 126. In exemplary embodiments, one or more cost data collection GUI displays including generic questions pertaining to the user's current costs follow the product-specific and/or product area-specific data collection GUI displays. As described above, for each of the GUI displays, the user inputs received are stored in response database objects 142 in the database 104 that maintain the association between the received user input values, their corresponding GUI database objects 122 and/or question objects 128, and the presentation database object 140.

In exemplary embodiments, after the user has progressed through all of the data collection GUI displays in the ROI presentation sequence, the presentation process 200 continues by obtaining the GUI database object corresponding to the ROI results GUI display in the presentation sequence, obtaining the valuation metric formula database objects associated with the selected products and/or selected product metric areas, calculating or otherwise determining projected values for those valuation metrics based on received user input values using the corresponding valuation metric formulas, and generating or otherwise providing the ROI results GUI display that includes graphical representations of the projected valuation metric values for the selected products and/or selected product metric areas (tasks 220, 222, 224, 226). In this regard, the application code 120 may identify the GUI display database object 122 corresponding to the ROI results GUI display as being the next GUI display in the presentation sequence after the user has completed all of the data collection GUI displays corresponding to the selected products and/or selected product areas. The metadata of the ROI results GUI display database object 122 may include code segments or scripts that cause the processing system 110 and/or application platform 112 to automatically obtain the formula database objects 128 associated with the selected products and/or selected product areas when generating the ROI results GUI display. For example, code segments or scripts for populating the ROI results GUI display may cause the processing system 110 and/or application platform 112 to access the presentation database object 140 for the current presentation to identify the response database objects 142 associated with the current presentation that correspond to the products and/or product areas that were input or otherwise selected by the user. Thereafter, the processing system 110 and/or application platform 112 may utilize the values indicative of the selected products and/or selected product areas that were obtained or otherwise identified from the metadata of those response database objects 142 to identify the formula objects 130 associated with the selected products and/or selected product areas. In this manner, the processing system 110 and/or application platform 112 identifies a formula database object 130 associated with the selected product(s) and/or selected product area(s) based on one or more fields of metadata associated with the formula database object 130 indicating an association between the formula database object 130 and the product database object 124 and/or product area object 126 for the selected product(s) and/or selected product area(s).

For each valuation metric formula obtained by the processing system 110 and/or application platform 112, the processing system 110 and/or application platform 112 calculates a corresponding projected (or estimated) value for that valuation metric as a function of the received user input values that correspond to the variables or parameters of that respective valuation metric formula. For example, a valuation metric formula object 130 may include metadata that defines the formula for calculating the projected value for that valuation metric as a function of the response database objects 142 corresponding to various question objects 128 previously presented to the user. In this regard, the processing system 110 and/or application platform 112 obtains the valuation metric formula from a respective valuation metric formula object 130, identifies the response database objects 142 referenced by that valuation metric formula, obtains the received user input values from those identified response database objects 142, and calculates the projected value for that valuation metric as a function of those received user input values in accordance with the formula defined by that valuation metric formula object 130.

After calculating projected values for each of the valuation metrics associated with the selected products and/or selected product areas, the processing system 110 and/or application platform 112 generates the ROI results GUI display within the virtual application 116 by populating the ROI results GUI display with graphical representations of the projected valuation metric values in the manner indicated by the ROI results GUI display database object 122. For example, the ROI results GUI display may include a table that is populated with the projected values for each of the valuation metrics associated with the selected products and/or selected product areas. In some embodiments, the ROI results GUI display may include one or more graphs, charts, plots, diagrams, or the like that graphically present the relationship between the projected values for one or more valuation metrics with respect to another variable, parameter, and/or value.

FIGS. 3-9 illustrate an exemplary sequence of GUI displays that may be graphically presented by the processing system 110 and/or application platform 112 within the client application 114 executing on the client device 106 via the virtual application 116 in connection with an exemplary embodiment of the presentation process 200 of FIG. 2. In this regard, the displays illustrated in FIGS. 3-9 represent a portion of the visual area on the electronic display device associated with client device 106 that contains graphical representations or images associated with the client application 114 which generates, conveys, renders, or otherwise displays graphical representations or images based on data received from the processing system 110 and/or the application platform 112 via the virtual application 116.

FIG. 3 illustrates an exemplary presentation definition GUI display 300 that may be generated or otherwise provided within the virtual application 116 as an initial GUI display of a presentation sequence being implemented by the presentation process 200. As described above, the processing system 110 and/or the application platform 112 may obtain and execute the ROI application code 120 stored on the database 104, which in turn causes the processing system 110 and/or the application platform 112 to obtain a GUI display database object 122 corresponding to the presentation definition GUI display 300 and generate the presentation definition GUI display 300 based on the metadata associated with that GUI display database object 122. In the illustrated embodiment, the metadata associated with the presentation definition GUI display object 122 defines a plurality of GUI input elements 302, 304, 306, 308 (e.g., text boxes or the like) adapted to allow the user to provide input defining a new presentation being created. Thereafter, the user may manipulate the client device 106 and/or the client application 114 to provide the desired name for the presentation in text box 302, an identification of a particular user (e.g., user object 148) to associate the presentation with in text box 304, an identification of a particular account (e.g., account object 144) to associate the presentation with in text box 306, and/or an identification of a particular opportunity (e.g., opportunity object 146) to associate the presentation with in text box 308. As illustrated, the text boxes 304, 306, 308 may include or otherwise incorporate search functionality that facilitates searching the database 104 for user database objects, account database objects, and/or opportunity database objects associated with the user of the client device 106 and/or the user's tenant matching the input provided in the respective text box 304, 306, 308. Additionally, in some embodiments, the presentation definition GUI display 300 may include one or more additional GUI elements 312 adapted to allow the user to associate the presentation with additional and/or different types of database objects associated with the user of the client device 106 and/or the user's tenant.

In exemplary embodiments, the presentation definition GUI display 300 includes a selectable GUI element 310 (e.g., a button or the like) that is selectable by the user to advance to the next GUI display of the presentation sequence. As described above, in response to the user manipulating the client device 106 and/or the client application 114 to select the GUI element 310, the processing system 110 and/or the application platform 112 receives indication that the user input values responsive to the presentation definition GUI display 300 have been received and captures the received user input values in the text boxes 302, 304, 306, 308 to create a presentation database object 140 having a name corresponding to the received user input value from text box 302 that is associated with the database objects 144, 146, 148 corresponding to the received user input values in text boxes 304, 306, 308. It should be noted that by virtue of the associating the presentation database object 140 with the other database objects 144, 146, 148 in the multi-tenant database 104, information pertaining to the presentation database object 140 may be presented when a user is viewing information pertaining to the associated database objects 144, 146, 148 via an instance of another virtual application 116 provided via the server 102. For example, a user associated with a particular tenant may access the multi-tenant database 104 via a virtual application 116 provided by the server 102 to view information pertaining to an account belonging to that user's tenant, wherein when the server 102 and/or virtual application 116 provides the GUI display including information associated with the account object 144 for the selected account, the server 102 and/or virtual application 116 may also provide, within the GUI display, information identifying a stored presentation (e.g., presentation database object 140) associated with the selected account.

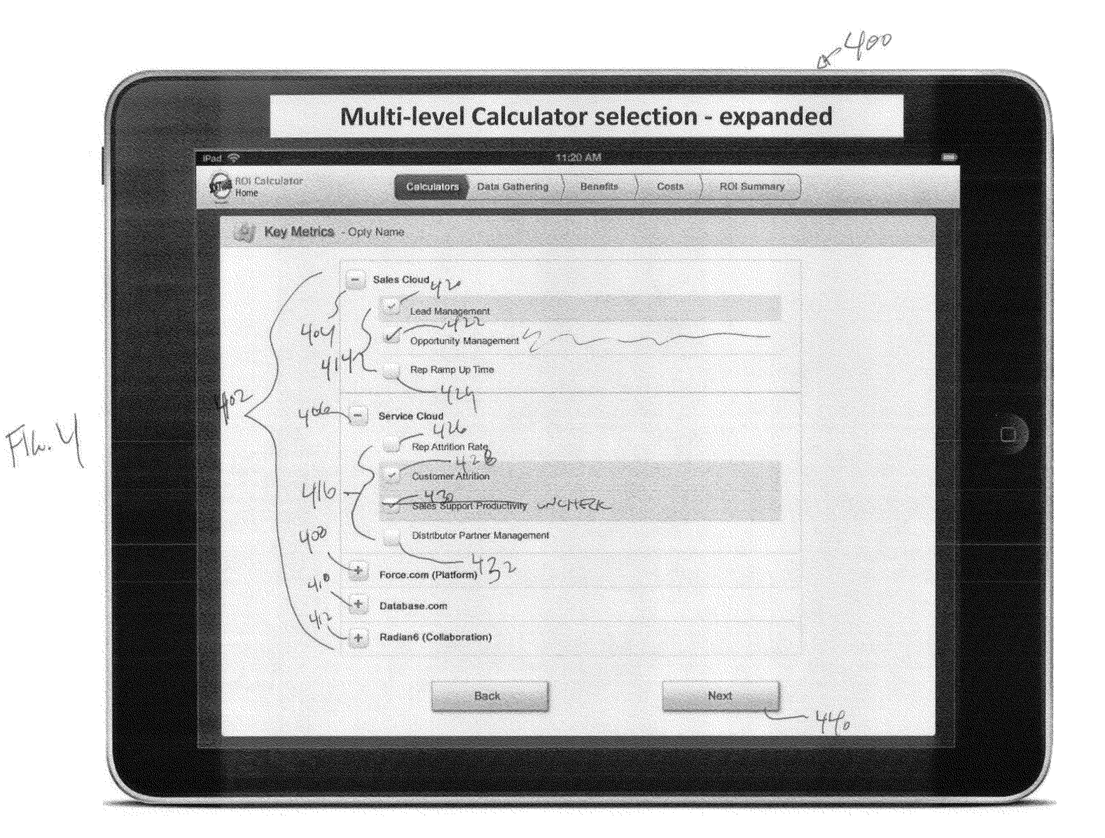

Turning now to FIG. 4, after receiving indication the presentation definition GUI display 300 has been completed, the code 120 causes the processing system 110 and/or the application platform 112 to obtain a GUI display database object 122 corresponding to the product selection GUI display 400 (e.g., the next GUI display in the presentation sequence) and generate the product selection GUI display 400 based on the metadata associated with that GUI display database object 122. In this regard, as described above, the product selection GUI display database object 122 may include code segments or scripts that cause the processing system 110 and/or the application platform 112 to access the database 104 to identify or otherwise obtain each product database object 124 that is active or otherwise available for inclusion in the presentation and generate a menu or list 402 containing the names of the active products with corresponding GUI elements 404, 406, 408, 410, 412 configured to allow the user to select products for inclusion in the presentation. As illustrated, in response to the user manipulating a GUI element 404, 406 to select a particular product for inclusion in the presentation, the processing system 110 and/or the application platform 112 executes additional code segments or scripts associated with the product selection GUI display database object 122 to access the database 104 and identify or otherwise obtain each product area object 126 associated with the selected product and generate a sub-menu or list 414, 416 containing the names of the product areas associated with the selected product with corresponding GUI elements 420, 422, 424, 426, 428, 430, 432 configured to allow the user to select product areas for inclusion in the presentation.

In a similar manner as described above, the product selection GUI display 400 includes a selectable GUI element 440 (e.g., a button or the like) that is selectable by the user to advance to the next GUI display of the presentation sequence, and in response to the user selecting the GUI element 440, the processing system 110 and/or the application platform 112 identifies the received user input selecting products and/or product areas for inclusion in the presentation based on the state of GUI elements 404, 406, 420, 422, 428. Thereafter, the processing system 110 and/or the application platform 112 generates corresponding response database objects 142 associated with the presentation database object 140 and having associated received user input values corresponding to the products and/or product areas associated with the GUI elements 404, 406, 420, 422, 428.

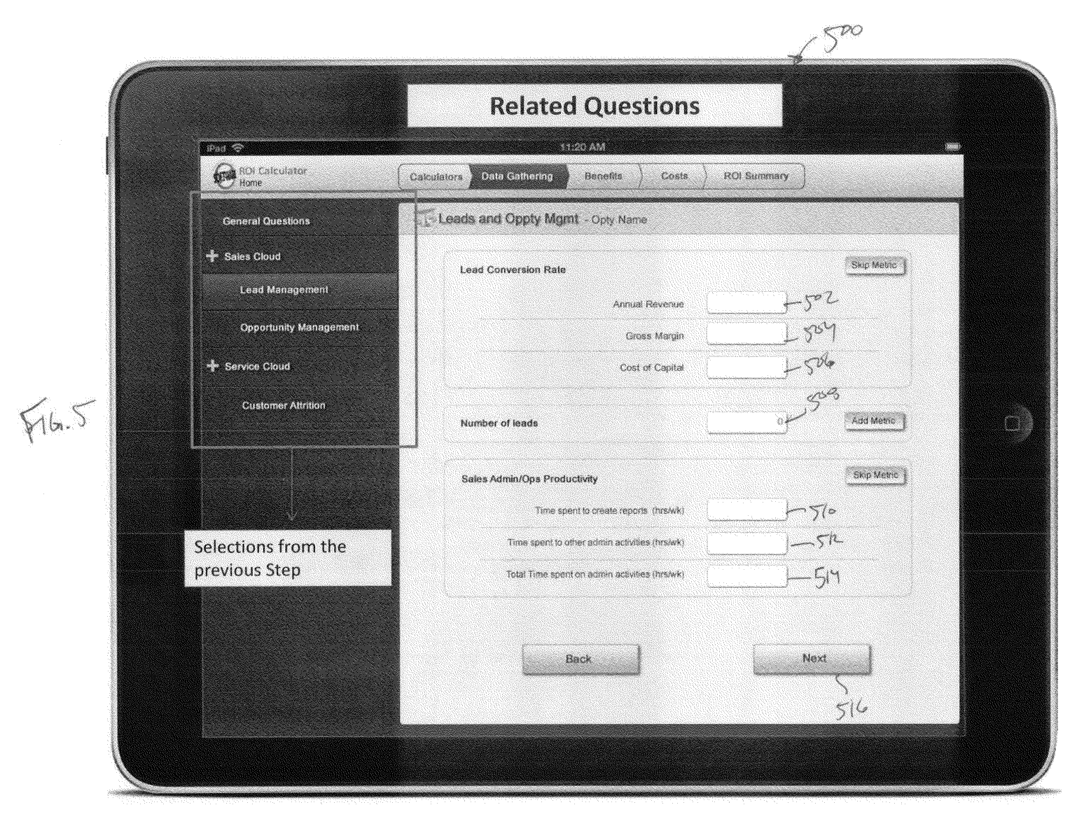

Turning now to FIG. 5, after receiving indication the product selection GUI display 400 has been completed by the user, the code 120 causes the processing system 110 and/or the application platform 112 to obtain one or more GUI database objects 122 corresponding to one or more data collection GUI displays following the product selection GUI display 400 in the presentation sequence, such as data collection GUI display 500. In this regard, as described above, the data collection GUI display database object 122 may include code segments or scripts that cause the processing system 110 and/or the application platform 112 to access the response database objects 142 associated with the presentation object 140 to identify or otherwise obtain the user's selected product areas and thereafter obtain the question database objects 128 associated with the respective product areas. Thereafter, the processing system 110 and/or the application platform 112 generates the data collection GUI display 500 corresponding to a respective selected product area that includes GUI input elements 502, 504, 506, 508, 510, 512, 514 (e.g., text boxes or the like) capable of receiving user input values responsive to the questions, labels and/or prompts associated with the respective GUI input elements 502, 504, 506, 508, 510, 512, 514. Depending on the embodiment, a data collection GUI display 500 may include generic questions (e.g., corresponding to text boxes 502, 504, 506) and/or product-specific and/or product area-specific questions (e.g., corresponding to text boxes 508, 510, 512, 514). In response to the user selecting a selectable GUI element 516, the processing system 110 and/or the application platform 112 captures or otherwise receives the user input values from the text boxes 502, 504, 506, 508, 510, 512, 514 and generates corresponding response database objects 142 associated with the presentation object 140 that maintain the received user input values in association with their corresponding GUI display object 122 and/or question object 128 from which those received user input values were obtained.

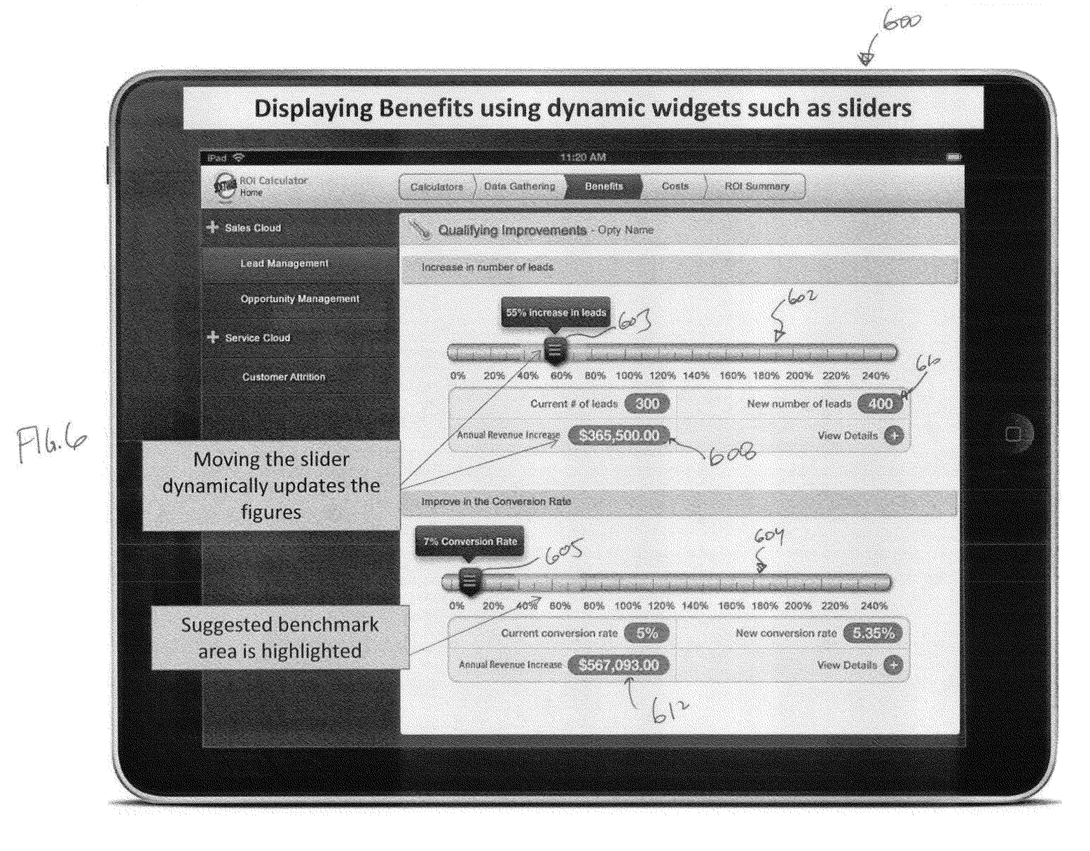

Turning now to FIG. 6, in accordance with one or more embodiments, prior to advancing to cost data collection GUI displays, the presentation sequence defined by the application code 120 includes a projected improvement GUI display 600 that includes GUI elements 602, 604 adapted to allow the user to estimate or otherwise quantify a parameter associated with a selected product and/or product area, such as, for example, the user's expected improvements with respect to one or more aspects of a selected product and/or product area. The illustrated projected improvement GUI display 600 includes sliders 602, 604 that allow the user to manipulate or otherwise vary the expected improvement with respect to a particular aspect of a selected product and/or product area based on position of a respective slider bar 603, 605 overlying a respective slider path. A slider GUI element 602, 604 may be generated based on a corresponding question object 128 that includes metadata that defines a range of possible values (e.g., minimum and/or maximum values) corresponding to the endpoints of the slider path along with metadata that references one or more formula objects 130 corresponding to one or more valuation metrics associated with the particular product and/or product area that are calculated or otherwise determined as a function of previously received user input values and the current value (or position) of the slider bar. In this regard, as the user manipulates the position of a slider bar 603, 605 overlying a respective slider path, the processing system 110 and/or the application platform 112 may dynamically update GUI elements 608, 610, 612 of the projected improvement GUI display 600 corresponding to those valuation metrics to reflect the current position of the slider bar 603, 605. As illustrated, the question object 128 for a slider GUI element 602, 604 may also include metadata that defines values for the likely range of values for the parameter corresponding to the slider GUI element 602, 604 (e.g., the likely range of improvements), so that the portion of a slider path corresponding to the likely range of values may be rendered in a manner that is visually distinguishable (e.g., using a different color, pattern, or the like) from the remaining portions of the respective slider path. After the user finishes manipulating the sliders 602, 604, the processing system 110 and/or the application platform 112 identifies the user input value based on the position of a respective slider bar 603, 605 with respect to the range of possible values for the underlying slider path and generates corresponding response database objects 142 associated with the presentation object 140 that maintain the received user input value corresponding to the position of a slider bar 603, 605 in association with the corresponding GUI display object 122 and/or question object 128.

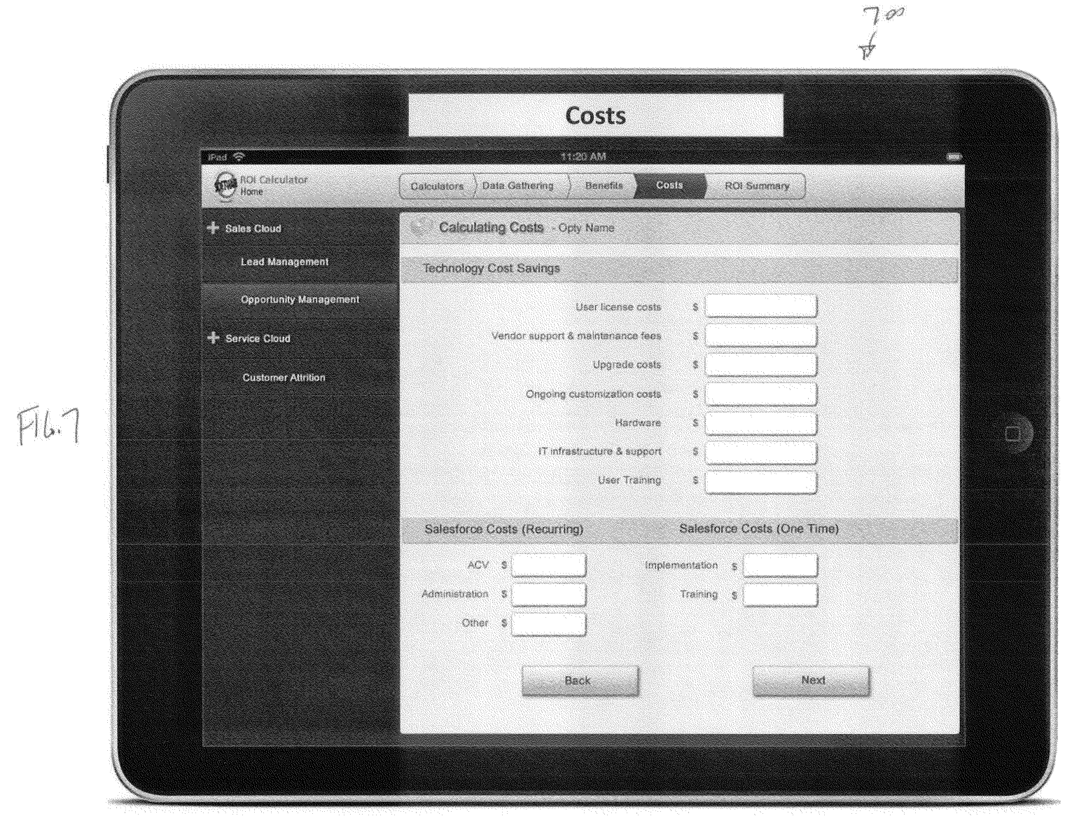

FIG. 7 illustrates an exemplary cost data collection GUI display 700 that may be presented in the presentation sequence after the projected improvement GUI display 600. In a similar manner as described above in the context of the data collection GUI display 500 of FIG. 5, the cost data collection GUI display 700 includes GUI input elements (e.g., text boxes or the like) capable of receiving user input values responsive to the questions, labels and/or prompts, which, depending on the embodiment, may include generic cost questions, product-specific cost questions, and/or product area-specific cost questions. Again, the processing system 110 and/or the application platform 112 captures or otherwise receives the user input values responsive to the cost questions and generates corresponding response database objects 142 associated with the presentation object 140.

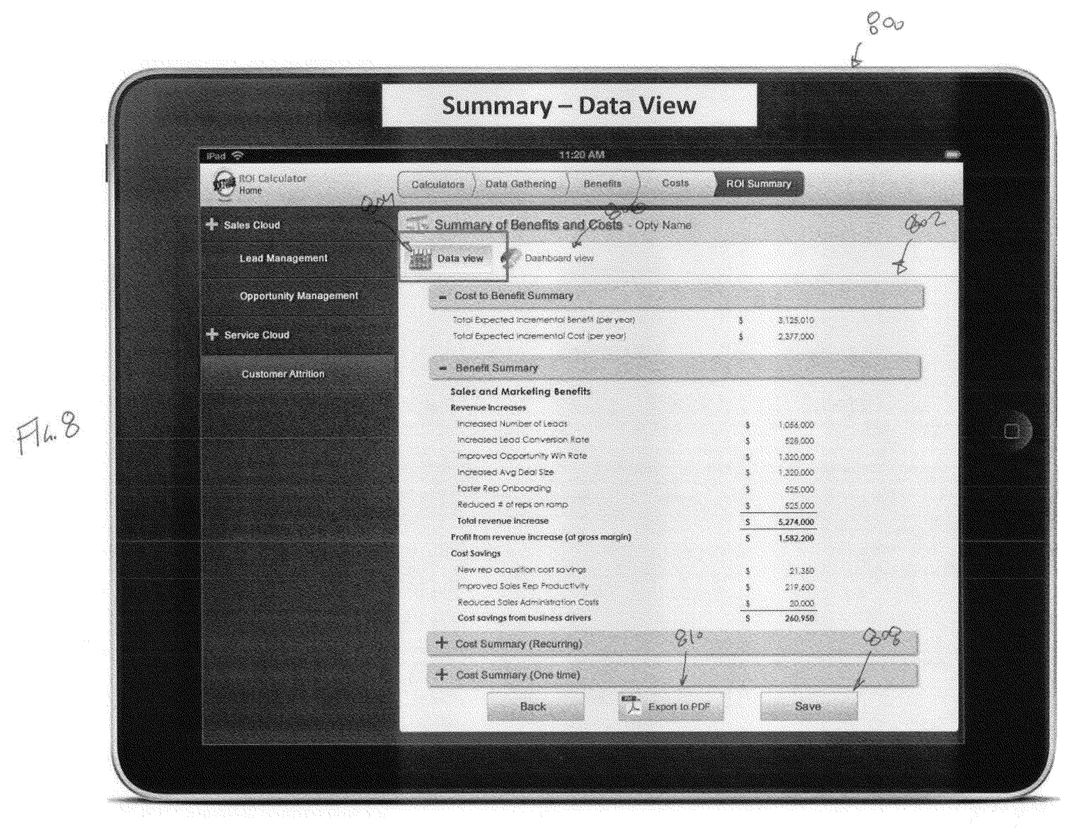

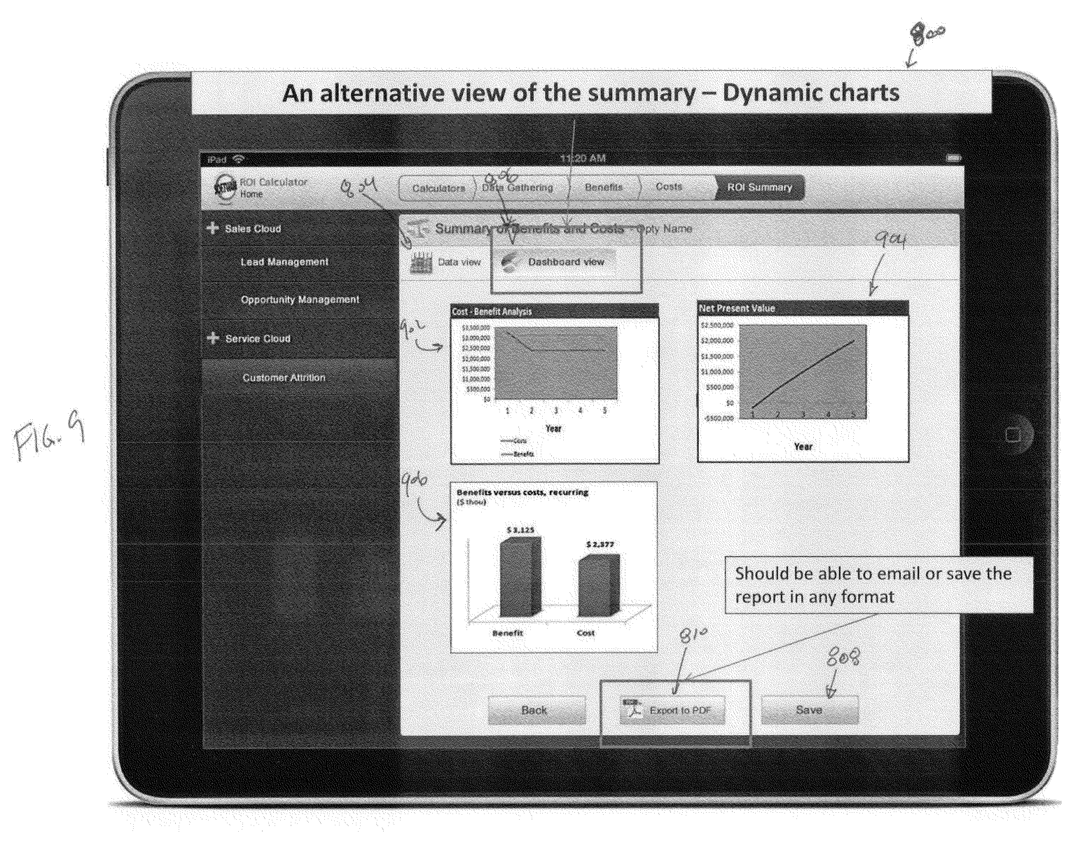

Turning now to FIGS. 8-9, in exemplary embodiments, after the user progresses through the data collection GUI displays of the presentation sequence, the application code 120 causes the processing system 110 and/or the application platform 112 to generate a ROI results GUI display 800 that includes graphical representations of projected values for the various valuation metrics that were calculated as a function of one or more received user input values. In the illustrated embodiment of FIG. 8, the ROI results GUI display 800 includes a table 802 containing projected values for valuation metrics that were calculated based at least in part on the received user input values responsive to the preceding GUI displays 400, 500, 600, 700 in the presentation sequence. As illustrated in FIG. 9, the ROI results GUI display 800 may include a selectable GUI element 806 that, when selected by the user, causes the causes the processing system 110 and/or the application platform 112 to generate one or more pictorial representations 902, 904, 906 (e.g., graphs, plots, charts, diagrams, or the like) of the relationship between one or more of the valuation metrics with respect to another parameter and/or variable that are presented in lieu of the table 802. To revert back the table 802, the user may select another selectable GUI element 804. Additionally, the ROI results GUI display 800 may include a selectable GUI element 808 that, when selected by the user, causes the processing system 110 and/or the application platform 112 to store or otherwise maintain the projected values for the valuation metrics (or the tabular or pictorial representations thereof) to the database 104 in association with the presentation object 140. In other embodiments, the selectable GUI element 808 may cause the client application 114 to store the projected values for the valuation metrics to the client device 106. The display 800 may also include a selectable GUI element 810 that, when selected by the user, causes the processing system 110 and/or the application platform 112 to convert or otherwise transform the projected values (or the tabular or pictorial representations thereof) to a particular format suitable for generating or otherwise creating a particular type of file containing the projected values that may be stored in the database 104, on the client device 106 and/or communicated to another user and/or client device via the network 108.

Still referring to FIGS. 3-9, as described above, the on-demand application system 100 and/or presentation process 200 described above facilitate modifying the GUI displays of a presentation sequence to support new products and/or product areas or to remove products and/or product areas from presentations in a manner that does not require modifications to the application code 120. For example, the corresponding product database objects 124 and/or product area objects 126 only need to be created, deleted, or otherwise modified accordingly in the database 104 (e.g., by changing a status field of metadata from active to inactive or vice versa). In this regard, content of the lists 402, 414, 416 and the corresponding GUI elements presented in the product selection GUI display 400 may be modified and automatically presented to users during subsequent iterations of the presentation process 200 without modifying the application code 120 or any code segments and/or scripts associated with the GUI display database object 122 for the product selection GUI display 400. Similarly, to modify, add, or remove questions presented in subsequent GUI displays, the corresponding question objects 128 only need to be modified, added, or removed in the database 104, thereby allowing different questions to be presented to users during subsequent iterations of the presentation process 200 without modifying the application code 120 or any code segments and/or scripts associated with the GUI objects 122 for the data collection GUI displays. Likewise, to modify the manner in which particular valuation metrics are calculated, the corresponding formula objects 130 in the database 104 may be modified accordingly, so that thereafter, the processing system 110 and/or application platform 112 automatically calculates the projected values for those particular valuation metrics in accordance with the modified formulas without modifying the application code 120 or any code segments and/or scripts associated with the GUI display database object 122 for the ROI results GUI display 800. Additionally, the GUI displays and/or the ordering thereof may be modified without modifying the application code 120, for example, by creating new GUI display database objects 122, deleting and/or deactivating existing GUI display database objects 122 and/or modifying the associated fields of metadata indicating the order of the respective GUI display database objects 122 in the presentation sequence.

In exemplary embodiments, the calculated projected values for the investment valuation metrics are stored in association with the presentation database object 140 in the database 104 (e.g., as response database objects 142 associated with the ROI results GUI display database object 122), thereby allowing the calculated projected values to be subsequently retrieved by the user and/or a different user associated with the same tenant. For example, the presentation sequence may include a GUI element adapted to allow a user to select or otherwise indicate a desire to review an existing presentation, wherein in response to receiving indication of the desire to review an existing presentation, the processing system 110 and/or application platform 112 access the database 104 to identify any presentation database objects 140 associated with the user and generate or otherwise provide GUI elements that allow the user to select a particular presentation for review. As a result, the presentation is portable and may be accessed by the same user via multiple different client devices and/or by different users across multiple different client devices. The GUI displays for the existing presentation may include GUI elements adapted to allow the user to revisit data collection GUI displays to modify user input values for various questions and/or prompts and update or otherwise overwrite the user input values for the corresponding response database objects 142 with the modified user input values. Thereafter, the user may return to the ROI results GUI display within the presentation to obtain modified projected valuation metric values calculated based at least in part on the modified user input values.

FIG. 10 depicts an exemplary embodiment of a multi-tenant system 1000 suitable for use as the on-demand application system 100 of FIG. 1. The illustrated multi-tenant system 1000 of FIG. 10 includes a server 1002 (e.g., server 102) that dynamically creates and supports virtual applications 1028 (e.g., virtual application 116) based upon data 1032 from a common database 1030 (e.g., database 104) that is shared between multiple tenants, alternatively referred to herein as a multi-tenant database. Data and services generated by the virtual applications 1028 are provided via a network 1045 (e.g., network 108) to any number of client devices 1040 (e.g., client device 106, or the like), as desired. Each virtual application 1028 is suitably generated at run-time (or on-demand) using a common application platform 1010 (e.g., application platform 112) that securely provides access to the data 1032 in the database 1030 for each of the various tenants subscribing to the multi-tenant system 1000. In accordance with one non-limiting example, the multi-tenant system 1000 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 1030. In this regard, each tenant includes one or more users associated with, assigned to, or otherwise belonging to that respective tenant. To put it another way, each respective user within the multi-tenant system 1000 is associated with, assigned to, or otherwise belongs to a particular tenant of the plurality of tenants supported by the multi-tenant system 1000. Tenants may represent customers, customer departments, business or legal organizations, and/or any other entities that maintain data for particular sets of users within the multi-tenant system 1000 (i.e., in the multi-tenant database 1030). For example, the application server 1002 may be associated with one or more tenants supported by the multi-tenant system 1000. Although multiple tenants may share access to the server 1002 and the database 1030, the particular data and services provided from the server 1002 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 1032 belonging to or otherwise associated with other tenants.

The multi-tenant database 1030 is any sort of repository or other data storage system capable of storing and managing the data 1032 associated with any number of tenants. The database 1030 may be implemented using any type of conventional database server hardware. In various embodiments, the database 1030 shares processing hardware 1004 with the server 1002. In other embodiments, the database 1030 is implemented using separate physical and/or virtual database server hardware that communicates with the server 1002 to perform the various functions described herein. In an exemplary embodiment, the database 1030 includes a database management system or other equivalent software capable of determining an optimal query plan for retrieving and providing a particular subset of the data 1032 to an instance of virtual application 1028 in response to a query initiated or otherwise provided by a virtual application 1028. The multi-tenant database 1030 may alternatively be referred to herein as an on-demand database, in that the multi-tenant database 1030 provides (or is available to provide) data at run-time to on-demand virtual applications 1028 generated by the application platform 1010.

In practice, the data 1032 may be organized and formatted in any manner to support the application platform 1010. In various embodiments, the data 1032 is suitably organized into a relatively small number of large data tables to maintain a semi-amorphous “heap”-type format. The data 1032 can then be organized as needed for a particular virtual application 1028. In various embodiments, conventional data relationships are established using any number of pivot tables 1034 that establish indexing, uniqueness, relationships between entities, and/or other aspects of conventional database organization as desired. Further data manipulation and report formatting is generally performed at run-time using a variety of metadata constructs. Metadata within a universal data directory (UDD) 1036, for example, can be used to describe any number of forms, reports, workflows, user access privileges, business logic and other constructs that are common to multiple tenants. Tenant-specific formatting, functions and other constructs may be maintained as tenant-specific metadata 1038 for each tenant, as desired. Rather than forcing the data 1032 into an inflexible global structure that is common to all tenants and applications, the database 1030 is organized to be relatively amorphous, with the pivot tables 1034 and the metadata 1038 providing additional structure on an as-needed basis. To that end, the application platform 1010 suitably uses the pivot tables 1034 and/or the metadata 1038 to generate “virtual” components of the virtual applications 1028 to logically obtain, process, and present the relatively amorphous data 1032 from the database 1030.

The server 1002 is implemented using one or more actual and/or virtual computing systems that collectively provide the dynamic application platform 1010 for generating the virtual applications 1028. For example, the server 1002 may be implemented using a cluster of actual and/or virtual servers operating in conjunction with each other, typically in association with conventional network communications, cluster management, load balancing and other features as appropriate. The server 1002 operates with any sort of conventional processing hardware 1004, such as a processor 1005, memory 1006, input/output features 1007 and the like. The input/output features 1007 generally represent the interface(s) to networks (e.g., to the network 1045, or any other local area, wide area or other network), mass storage, display devices, data entry devices and/or the like. The processor 1005 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 1006 represents any non-transitory short or long term storage or other computer-readable media capable of storing programming instructions for execution on the processor 1005, including any sort of random access memory (RAM), read only memory (ROM), flash memory, magnetic or optical mass storage, and/or the like. The computer-executable programming instructions, when read and executed by the server 1002 and/or processor 1005, cause the server 1002 and/or processor 1005 to create, generate, or otherwise facilitate the application platform 1010 and/or virtual applications 1028 and perform one or more additional tasks, operations, functions, and/or processes described herein. It should be noted that the memory 1006 represents one suitable implementation of such computer-readable media, and alternatively or additionally, the server 1002 could receive and cooperate with external computer-readable media that is realized as a portable or mobile component or application platform, e.g., a portable hard drive, a USB flash drive, an optical disc, or the like.

The application platform 1010 is any sort of software application or other data processing engine that generates the virtual applications 1028 that provide data and/or services to the client devices 1040. In a typical embodiment, the application platform 1010 gains access to processing resources, communications interfaces and other features of the processing hardware 1004 using any sort of conventional or proprietary operating system 1008. The virtual applications 1028 are typically generated at run-time in response to input received from the client devices 1040. For the illustrated embodiment, the application platform 1010 includes a bulk data processing engine 1012, a query generator 1014, a search engine 1016 that provides text indexing and other search functionality, and a runtime application generator 1020. Each of these features may be implemented as a separate process or other module, and many equivalent embodiments could include different and/or additional features, components or other modules as desired.

The runtime application generator 1020 dynamically builds and executes the virtual applications 1028 in response to specific requests received from the client devices 1040. The virtual applications 1028 are typically constructed in accordance with the tenant-specific metadata 1038, which describes the particular tables, reports, interfaces and/or other features of the particular application 1028. In various embodiments, each virtual application 1028 generates dynamic web content that can be served to a browser or other client program 1042 associated with its client device 1040, as appropriate.

The runtime application generator 1020 suitably interacts with the query generator 1014 to efficiently obtain multi-tenant data 1032 from the database 1030 as needed in response to input queries initiated or otherwise provided by users of the client devices 1040. In a typical embodiment, the query generator 1014 considers the identity of the user requesting a particular function (along with the user's associated tenant), and then builds and executes queries to the database 1030 using system-wide metadata 1036, tenant specific metadata 1038, pivot tables 1034, and/or any other available resources. The query generator 1014 in this example therefore maintains security of the common database 1030 by ensuring that queries are consistent with access privileges granted to the user and/or tenant that initiated the request. In this manner, the query generator 1014 suitably obtains requested subsets of data 1032 accessible to a user and/or tenant from the database 1030 as needed to populate the tables, reports or other features of the particular virtual application 1028 for that user and/or tenant.

Still referring to FIG. 10, the data processing engine 1012 performs bulk processing operations on the data 1032 such as uploads or downloads, updates, online transaction processing, and/or the like. In many embodiments, less urgent bulk processing of the data 1032 can be scheduled to occur as processing resources become available, thereby giving priority to more urgent data processing by the query generator 1014, the search engine 1016, the virtual applications 1028, etc.

In exemplary embodiments, the application platform 1010 is utilized to create and/or generate data-driven virtual applications 1028 for the tenants that they support. Such virtual applications 1028 may make use of interface features such as custom (or tenant-specific) screens 1024, standard (or universal) screens 1022 or the like. Any number of custom and/or standard objects 1026 may also be available for integration into tenant-developed virtual applications 1028. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 1032 associated with each virtual application 1028 is provided to the database 1030, as appropriate, and stored until it is requested or is otherwise needed, along with the metadata 1038 that describes the particular features (e.g., reports, tables, functions, objects, fields, formulas, code, etc.) of that particular virtual application 1028. For example, a virtual application 1028 may include a number of objects 1026 accessible to a tenant, wherein for each object 1026 accessible to the tenant, information pertaining to its object type along with values for various fields associated with that respective object type are maintained as metadata 1038 in the database 1030. In this regard, the object type defines the structure (e.g., the formatting, functions and other constructs) of each respective object 1026 and the various fields associated therewith.

Still referring to FIG. 10, the data and services provided by the server 1002 can be retrieved using any sort of personal computer, mobile telephone, tablet or other network-enabled client device 1040 on the network 1045. In an exemplary embodiment, the client device 1040 includes a display device, such as a monitor, screen, or another conventional electronic display capable of graphically presenting data and/or information retrieved from the multi-tenant database 1030. Typically, the user operates a conventional browser application or other client program 1042 executed by the client device 1040 to contact the server 1002 via the network 1045 using a networking protocol, such as the hypertext transport protocol (HTTP) or the like. The user typically authenticates his or her identity to the server 1002 to obtain a session identifier (“SessionID”) that identifies the user in subsequent communications with the server 1002. When the identified user requests access to a virtual application 1028, the runtime application generator 1020 suitably creates the application at run time based upon the metadata 1038, as appropriate. As noted above, the virtual application 1028 may contain Java, ActiveX, or other content that can be presented using conventional client software running on the client device 1040; other embodiments may simply provide dynamic web or other content that can be presented and viewed by the user, as desired.

Still referring to FIG. 10, and with reference to FIGS. 1-2, in accordance with one or more embodiments, the presentation process 200 is implemented, supported, or otherwise performed by the runtime application generator 1020 of the application platform 112, 1010, which generates the virtual application 116 based on the data 1032 and/or metadata 1038 in the database 1030 corresponding to the GUI displays (e.g., screens 1022, 1024) and database objects (e.g., objects 1026) for the virtual application 116. As described above, the data and/or metadata associated with the respective presentation database objects 140 and response database objects 142 resulting from the presentation process 200 are stored by the runtime application generator 1020 in the multi-tenant database 1030 as tenant-specific objects associated with the tenant to which the user of a respective client device 106, 1040 belongs.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to web crawling, expression matching, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method of providing projected investment returns for a product to a user of a client device coupled to a server via a network, the method comprising:
obtaining, from a database coupled to the server, metadata from a database object associated with the product;
generating, by the server based on the metadata, a graphical user interface element within an application provided to the client device;
receiving, from the client device via the application, an input value responsive to the graphical user interface element;
obtaining, from the database, a formula for a valuation metric;
calculating a projected value for the valuation metric based at least in part on the input value using the formula; and
generating a graphical representation of the projected value within the application.

2. The method of claim 1, further comprising:
generating, by the server, a first graphical user interface display within the application, the first graphical user interface display comprising a first plurality of graphical user interface elements corresponding to a plurality of product database objects in the database;
receiving indication of a selected product via the first plurality of graphical user interface elements; and
identifying a first product database object of the plurality of product database objects corresponding to the selected product, wherein:
obtaining the metadata comprises obtaining the metadata from a second database object associated with the first product database object; and
generating the graphical user interface element comprises generating a second graphical user interface display within the application, the second graphical user interface display including the graphical user interface element.

3. The method of claim 1, further comprising:
generating, by the server, a first graphical user interface display within the application, the first graphical user interface display comprising a first plurality of graphical user interface elements corresponding to a plurality of product database objects in the database;
receiving indication of a selected product via the first plurality of graphical user interface elements;
identifying a first product database object of the plurality of product database objects corresponding to the selected product;
identifying one or more product area database objects in the database associated with the first product database object; and
generating a second set of one or more graphical user interface elements corresponding to the one or more product area database objects based on second metadata associated with the one or more product area database objects.

4. The method of claim 3, further comprising:
receiving indication of a selected product area via the second set of one or more graphical user interface elements;
identifying a first product area database object of the one or more product area database objects corresponding to the selected product area; and
identifying a question database object associated with the first product area database object, wherein obtaining the metadata from the database object associated with the product comprises obtaining the metadata from the question database object associated with the first product area database object.

5. The method of claim 1, further comprising creating a response database object in the database corresponding to the input value responsive to the graphical user interface element, wherein:
obtaining the formula for the valuation metric comprises identifying a formula database object associated with the product in the database, the formula database object including second metadata defining the formula as a function of a response to the graphical user interface element; and
calculating the projected value comprises:
identifying the response database object based on the second metadata associated with the formula database object; and
calculating the projected value as a function of the input value associated with the response database object.

6. The method of claim 1, wherein obtaining the formula comprises:
identifying a formula database object associated with the product based on first metadata associated with the formula database object corresponding to a product database object corresponding to the product; and
obtaining second metadata associated with the formula database object defining the formula for the valuation metric.

7. The method of claim 6, further comprising:
storing the input value in a response database object in the database;
identifying the response database object based on the second metadata; and
prior to calculating the projected value, obtaining the input value from the response database object in response to identifying the response database object based on the second metadata.

8. The method of claim 1, wherein obtaining the metadata from the database object associated with the product comprises obtaining the metadata from a question database object associated with the product, wherein the metadata comprises code executable by the server to generate the graphical user interface element.

9. The method of claim 8, further comprising:
identifying one or more product area database objects associated with a product database object corresponding to the product, the one or more product area database objects corresponding to one or more product areas associated with the product;
obtaining second metadata pertaining to the one or more product areas from the one or more product area database objects;
generating, based on the second metadata, a second set of one or more graphical user interface elements adapted to allow the user to select one or more of the product areas;
receiving, from the client device via the application, indication of a selected product area responsive to the second set of one or more graphical user interface elements; and
identifying the question database object as being associated with the selected product area prior to obtaining the code.

10. The method of claim 1, the metadata defining a range of possible values, wherein:
generating the graphical user interface element comprises generating a slider including a slider bar overlying a slider path having endpoints corresponding to the range of possible values; and
receiving the input value responsive to the graphical user interface element comprises determining the input value corresponding to a position of the slider bar with respect to the slider path.

11. The method of claim 1, the metadata defining a range of values, wherein generating the graphical user interface element comprises generating a slider, wherein a portion of the slider corresponding to the range of values is displayed using a visually distinguishable characteristic.

12. A system comprising:
a database to store a database object associated with a product and a formula object associated with a valuation metric, the formula object including a formula for calculating a projected value for the valuation metric; and
a server coupled to the database to obtain metadata associated with the database object, generate a graphical user interface element based on the metadata, receive a user input value via the graphical user interface element, obtain the formula from the formula object, calculate the projected value for the valuation metric based at least in part on the user input value using the formula, and generate a graphical representation of the projected value.

13. The system of claim 12, further comprising a client device coupled to the server via a network, wherein the server generates the graphical user interface element and the graphical representation of the projected value within an application provided to the client device via the network.

14. The system of claim 13, wherein:
the database comprises a multi-tenant database configured to support a plurality of tenants;
a user of the client device is associated with a first tenant of the plurality of tenants; and
the server is configured to create a presentation object in the database associated with the first tenant.

15. The system of claim 13, wherein the server executes code stored on the database to generate the application.

16. The system of claim 12, the database storing a presentation database object, wherein the server is configured to store at least one of the user input value and the projected value in the database in association with the presentation database object.

17. A computer-readable medium comprising computer-executable instructions that, when executed by a processing system, cause the processing system to:
obtain metadata from a database object associated with a product, the database object being stored in a database;
generate a graphical user interface element based on the metadata;
receive an input value responsive to the graphical user interface element;
obtain a formula for a valuation metric from the database;
calculate a projected value for the valuation metric based at least in part on the input value using the formula; and
generate a graphical representation of the projected value.

18. The computer-readable medium of claim 17, wherein the computer-executable instructions cause the processing system to:
generate a first graphical user interface display within an application provided to a client device via a network, the first graphical user interface display comprising a first plurality of graphical user interface elements corresponding to a plurality of product database objects in the database;
receive indication of a selected product via the first plurality of graphical user interface elements;
identify a first product database object of the plurality of product database objects corresponding to the selected product;
obtain the metadata from a second database object associated with the first product database object; and
generate a second graphical user interface display within the application, the second graphical user interface display including the graphical user interface element.

19. The computer-readable medium of claim 17, wherein the computer-executable instructions cause the processing system to:
generate a first graphical user interface display within an application provided to a client device via a network, the first graphical user interface display comprising a first plurality of graphical user interface elements corresponding to a plurality of product database objects in the database;
receive indication of a selected product via the first plurality of graphical user interface elements;
identify a first product database object of the plurality of product database objects corresponding to the selected product;
identify one or more product area database objects in the database associated with the first product database object; and
generate a second set of one or more graphical user interface elements corresponding to the one or more product area database objects based on second metadata associated with the one or more product area database objects.

20. The computer-readable medium of claim 17, wherein the computer-executable instructions cause the processing system to:
identify a formula database object in the database that is associated with the product based on first metadata associated with the formula database object corresponding to a product database object in the database that corresponds to the product; and
obtain second metadata associated with the formula database object, the second metadata defining the formula for the valuation metric.
